(19) United States
(12) Patent Application Publication
(10) Pub. No.: US 2019/0086936 A1
(43) Pub. Date: Mar. 21, 2019

(54) Surface Movement Awareness System - Commercial

(71) Applicants: Martin Schrage, Arlington, MA (US); Seth Schrage, BOSTON, MA (US)

(72) Inventors: Martin Schrage, Arlington, MA (US); Seth Schrage, Boston, MA (US)

(21) Appl. No.: 16/055,154

(22) Filed: Aug. 6, 2018

Related U.S. Application Data
(60) Provisional application No. 62/516,653, filed on Jun. 7, 2017.

(51) Int. Cl. G05D 1/08; B64D 45/04; G01C 23/00; G06F 3/0481; G06F 17/11

(52) U.S. Cl. CPC G05D 1/085; B64D 45/04; G06F 17/11; G06F 3/04817; G01C 23/005

(57) ABSTRACT

The present invention relates generally to the operation of aircraft maneuvering with its landing gear in contact with a surface. Multiple electromagnetic-wave sensors measure, with respect to the surface, the aircraft's lateral and longitudinal translational velocities, as well as the aircraft's yaw rate. Icons representing the measured velocities and rotations are displayed to onboard or remotely-located pilots of such aircraft to make them aware of slipping, side sliding, moving rearward, and other uncommanded movements caused by: low friction surfaces, wind buffeting, rolling and pitching platforms, and other disturbances. Pilots can use the increased awareness of the aircraft's movements with respect to the surface to take corrective action to prevent accidents.

These capabilities can further be exploited to display icons representing the alignment of the aircraft with respect to a surface as opposed to alignment with respect to the horizon as is the present practice. Profiles of the surface along with distances between the aircraft and the surfaces which may have sloping topography, or which may be the surface of a moving platform are also displayed to the onboard or remotely-located pilot of aircraft that are landing, taking off, or hovering near a surface.

### CROSS REFERENCE TO RELATED APPLICATIONS

This application claims priority of Provisional Application No. 62/516,653 entitled “Surface-Velocity Vector Sensor” filed on Jun. 7, 2017 and which is incorporated herein by reference.

### BACKGROUND OF THE INVENTION

Early experiments with operating an unmanned aerial vehicle (UAV) on an aircraft carrier deck revealed that existing pilot instruments in many situations fail to convey to the pilot that the aircraft is moving in an uncommanded manner. UAV's taxiing under their own power on the flight deck of a ship, may not always move in the commanded direction. Deck conditions, such as fluid on the deck, worn non-skid deck material or the motion of the ship, could cause the aircraft to slide or skid. See FIG. 3. An unmanned aerial vehicle's (UAV's) remotely located pilot, or onboard pilot, requires the ability to determine true direction and speed of motion particularly very low speeds with respect to the deck. This allows for detection of and reaction to sliding or skidding and/or to initiate appropriate emergency response if required.

The gyro compass onboard every aircraft measures the magnetic heading of the aircraft. Given the aircraft's magnetic heading and the magnetic heading of the ship, the heading of the aircraft's longitudinal movement (movement parallel to the fuselage) referenced to the vessel's keel can be readily determined with simple arithmetic and displayed to the remote pilot of a UAV. But a pitot tube air speed sensors only measures forward longitudinal speed with respect to the air and provides no indication of movement with respect to the surface, and only down into the 20 knot range—which is two orders of magnitude above the speed of a aircraft creeping along the deck. Satellite measurement systems, such as Geographic Positioning Systems (GPS) provide motion measurements with respect to a latitude and longitude earth-centered coordinate system not with respect to the surface in contact with the UAV's landing gear. Skidding and sliding can have lateral as well as longitudinal velocity. See FIG. 3. A sensor suite is needed which will measure and display to a pilot at least longitudinal and lateral translational movement and preferably rotational movement such as the yaw rate referenced to the deck as illustrated in FIG. 4. It is also necessary to make these measurements for speeds at least as low as 0.4 mph (7 inches/sec).

A taxiing aircraft's second-to-second movements with respect to the surface may be partially directed by a computer control system and partially by a driver. In the case of remotely controlled vehicles, the driver may be located at a distance from the vehicle and must rely on information delivered via a communication link to make control decisions. An autonomously operating vehicle would be completely directed by a computer system.

In all of the cases maintaining control of the aircraft's second-to-second movements on a surface requires measuring at least the aircraft's 2-D translational velocities and preferably rotational rates such as yaw with respect to the surface over which it is traveling and such measurements should be independent of the orientation of the surface with respect to the earth vertical. Orientation with respect to the earth vertical means orientation referenced to the local vertical defined by the direction of the gravitation lines of force at the location. An opportunity has arisen that provides a path to a solution to this problem

The automotive industry is installing tens-of-millions of precision short range radar systems in the worldwide automotive fleet. These meet strict safety and reliability standards operating in the hostel environment of the underside of passenger vehicles for a decade with no maintenance. These are available commercial-off-the-shelf (COTS) at unprecedented low prices as a result of the huge production volumes. The enables the installation of a number of COTS radar systems on an aircraft to solve aircraft operational problems.

Deng et al. U.S. Pat. No. 7,774,103 disclosed “Online estimation of vehicle side-slip under linear operating region”. This solution was based on the use of inertial sensors including linear accelerometers and yaw sensors to obtain a Kalman-filtering estimate of slide slip velocity as opposed to directly measuring the actual velocity over the surface.

Lhomme-Desages, D. et al; “Doppler-Based Ground Speed Sensor Fusion and Slip Control for a Wheeled Rover”; IEEE/ASME Transactions on Mechatronics VOL. 14, NO. 4, August 2009; discloses using a single forward looking Doppler radar to estimate wheel slippage. This approach provides no indication of lateral velocity.

Unger U.S. Pat. No. 9,618,627 disclosed a system for estimating side slip angle. Wood Wood Wood There is no measurement of movement with respect to the surface.

Mc Cusker, et al. U.S. Pat. No. 9,354,633 disclosed a navigation system for aircraft based on two radar sensors each mounted near the tips of the two wings of an aircraft to determine wing velocities. The invention includes providing navigation while the aircraft is taxiing.

Wood et al. U.S. Pat. No. 9,733,349 disclosed using radar to record the pattern spacing of runway lights and then entering a catalog of spacings for various airports.

It is therefore an object of this invention to improve the safety of aircraft maneuvering with their landing gear in contact with a surface by making their pilots aware of uncommanded movements of the aircraft in order for them to command corrective maneuvers.

It is further an object of this invention to measure translational velocities and rotational rates with respect to surface on which the aircraft is maneuvering when the surface is: rolling, pitching, or is fixed in space, but is inclined or banked.

It is further an object of this invention to make measurements of translational velocities and rotational rates of the aircraft by direct measurement with respect to the surface without the use of inertial accelerometers or gyroscopic sensors.

It is further an object of this invention to make translational velocity and rotational rate measurements of the aircraft with respect to the surface which may be granular with randomly oriented facets by scanning with coherent electromagnetic radiation whose wavelength is on the same order, or less, than the average dimensions of the facets and carrying out Doppler analysis of the reflected radiation.

It is further an object of this invention to provide the measurement of velocities as low as 0.4 mph (7 inches/sec).

It is further an object of this invention to communicate the velocity and rotational rate information to pilots onboard the aircraft or to remotely located pilots of aircrafts.

It is further an object of this invention to communicate very low speed measurements of two-dimensional movements to autonomously controlled aircraft.

It is further an object of this invention to provide a pilot of an aircraft operating near the surface with both 2-D movement information and information on the alignment of the aircraft with respect to the surface.

### SUMMARY OF THE INVENTION

The objects set forth above as well as further and other objects and advantages of the present invention are achieved by the embodiments of the invention described hereinbelow.

The present invention relates generally to the operation of a aircraft maneuvering with its landing gear in contact with a surface. Multiple electromagnetic-wave sensors measure, with respect to the surface, the aircraft's lateral and longitudinal translational velocities, as well as the aircraft's yaw rate. Icons representing the measured velocities and rotations are displayed to onboard or remotely-located pilots of such aircraft to make them aware of slipping, side sliding, moving rearward, and other uncommanded movements caused by: low friction surfaces, wind buffeting, rolling and pitching platforms, and other disturbances. Pilots can use the increased awareness of the aircraft's movements with respect to the surface to take corrective action to prevent accidents.

These capabilities can further be exploited for aircraft flying near the surface to display icons representing the alignment with respect to a surface as opposed to alignment with respect to the horizon as is the present practice. Profiles of the surface along with distances between the aircraft and the surfaces which may have sloping topography, or which may be the surface of a moving platform are also displayed to the onboard or remotely-located pilot of aircraft to improve the safety of landing, taking off, or hovering near a surface.

### BRIEF DESCRIPTIONS OF THE DRAWINGS

FIG. 1 pictorially represents the six-degrees-of-freedom coordinate system centered on the aircraft's center-of-gravity.

FIG. 2 pictorially represents the coordinate system centered on an aircraft.

FIG. 3 pictorially represents the icons displayed to a pilot when the aircraft is moving backward in the negative y-direction. The aircraft is located on a sloping surface and gravitational forces are causing it to slip backwards.

FIG. 4 pictorially represents the icons displayed to a pilot when the aircraft is moving forward in the positive y-direction.

FIG. 5 pictorially represents the icons displayed to a pilot when the aircraft is moving forward in the positive y-direction and is simultaneously sliding to the side in the negative x-direction. The slide to the side is due to the gravitational forces arising from a surface sloping to the side coupled and to the tires lacking friction sufficient to prevent the sideways sliding.

FIG. 6 pictorially represents the icons displayed to a pilot when the aircraft is subjected to a crosswind which is both causing sliding in the positive x-direction and is causing the aircraft to yaw in the clockwise direction.

FIG. 7 pictorially represents the icons presented to a pilot when the aircraft is in level flight over a sloping surface. The sensors scanning along the longitudinal axis produce a profile of the surface with respect to the aircraft. The fore and aft sensors measure the alignment of the aircraft with the surface.

FIG. 8 pictorially represents the icons presented to a pilot when the aircraft has rolled clockwise. The sensor has measured that roll with respect to the surface and used the amount of the roll to compute the alignment with the surface and have measured the profile of the surface with respect to the aircraft.

FIG. 9 pictorially represents an aircraft with a radar beam scanning in the +x direction.

FIG. 10 pictorially represents an aircraft with radar beams emanating from +d and −d from the center of gravity facilitating extracting yaw rate's contribution to translational velocity.

### DETAILED DESCRIPTION OF THE PREFERRED EMBODIMENTS

The disclosed design of a system for measuring low-speed (down to 0.4 mph) movement of taxiing UAV's is to aim 60-GHz (5 mm wavelength) radar beams at the surface and measure the frequency shift caused by the Doppler Effect. The nature of the radar returns depends on the surface granularity (“roughness”). The 5 mm wavelength of a 60-GHz wave is of the same order as the dimensions of the randomly oriented facets of the stones embedded in the asphalt roadway on which the invention was tested. Reflecting waves from an antenna whose dimensions are on the order of one wavelength results in approximately a 60-degree beam width of the emitted radiation. Thus some fraction of the randomly oriented facets will reflect waves in the direction of the radar illuminating the facet.

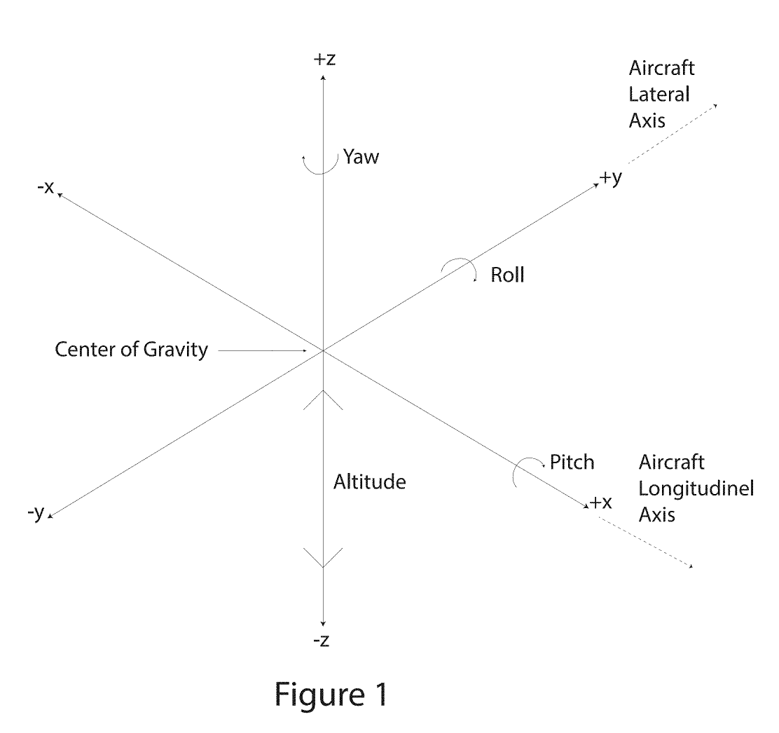

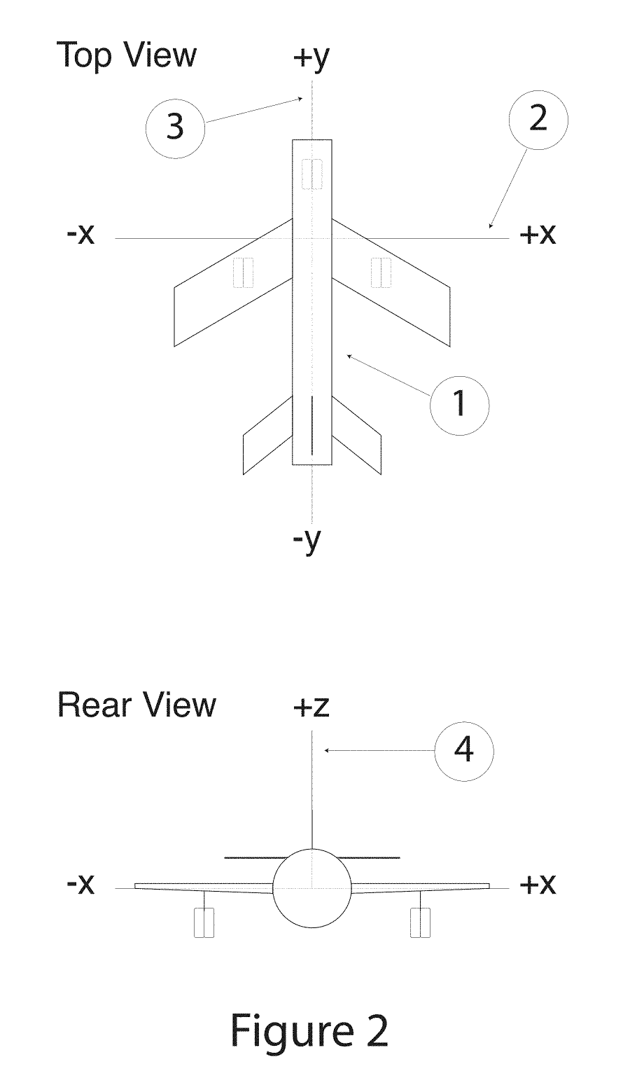

Throughout this disclosure the x-y-z orthogonal coordinate system illustrated in FIG. 1 will be used. FIG. 2 illustrates how the y-axis 3, the x-axis 2, and the z-axis 4 are aligned with an aircraft.

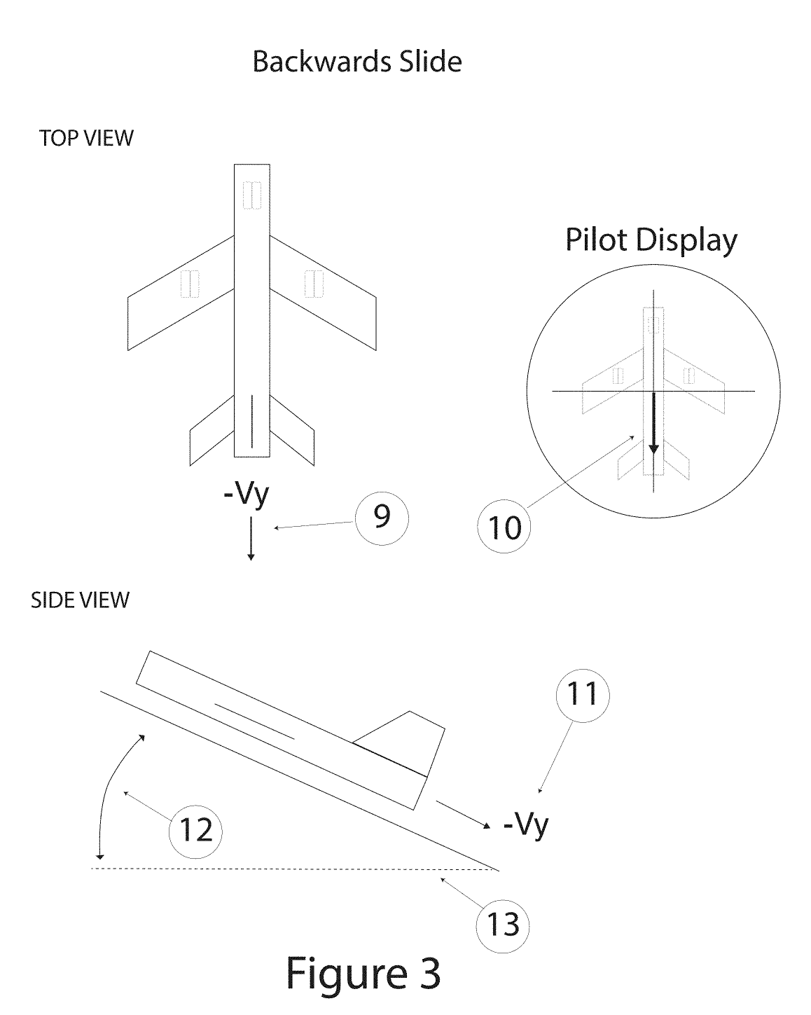

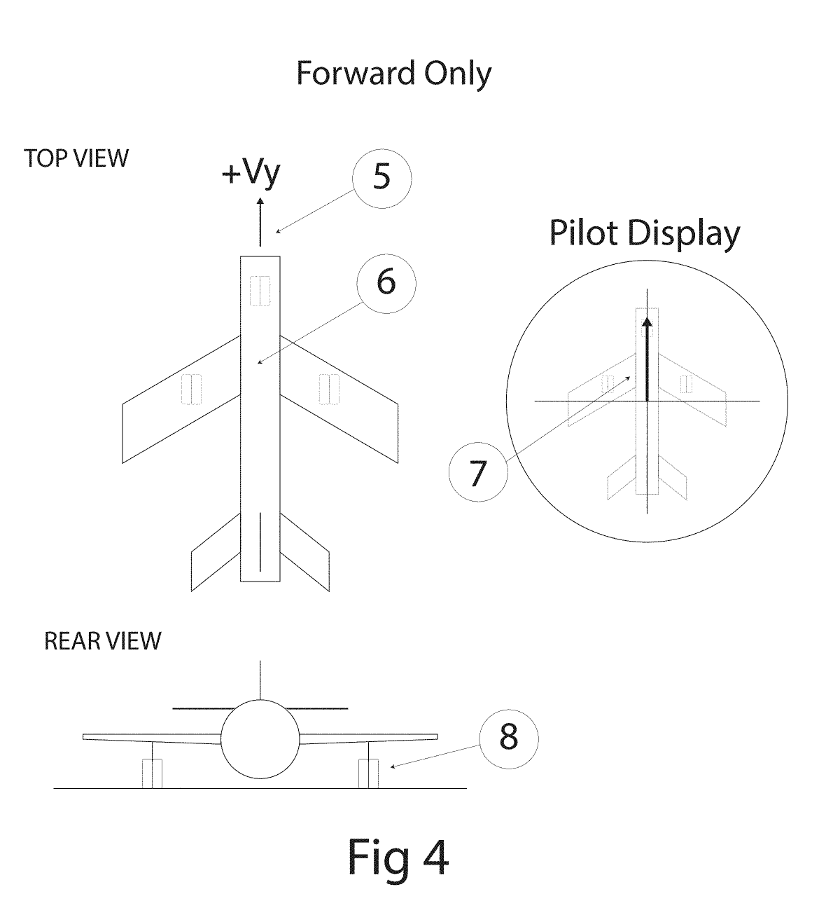

Backward longitudinal in the −y direction 9 and 11 is illustrated in FIG. 3. Slipping and sliding can be introduced by pitching and rolling of a platform resulting in sloping surfaces 12 as well as headwinds and cross winds. A UAV creeping forward under power could be moved backwards due to pitching of the surface as illustrated in FIG. 3. Such a backward movement is of course undetected by standard aircraft instrumentation (pitot tubes). An iconic representation 10 of the situation on a pilot display is shown. FIG. 4 shows the Pilot Display 7

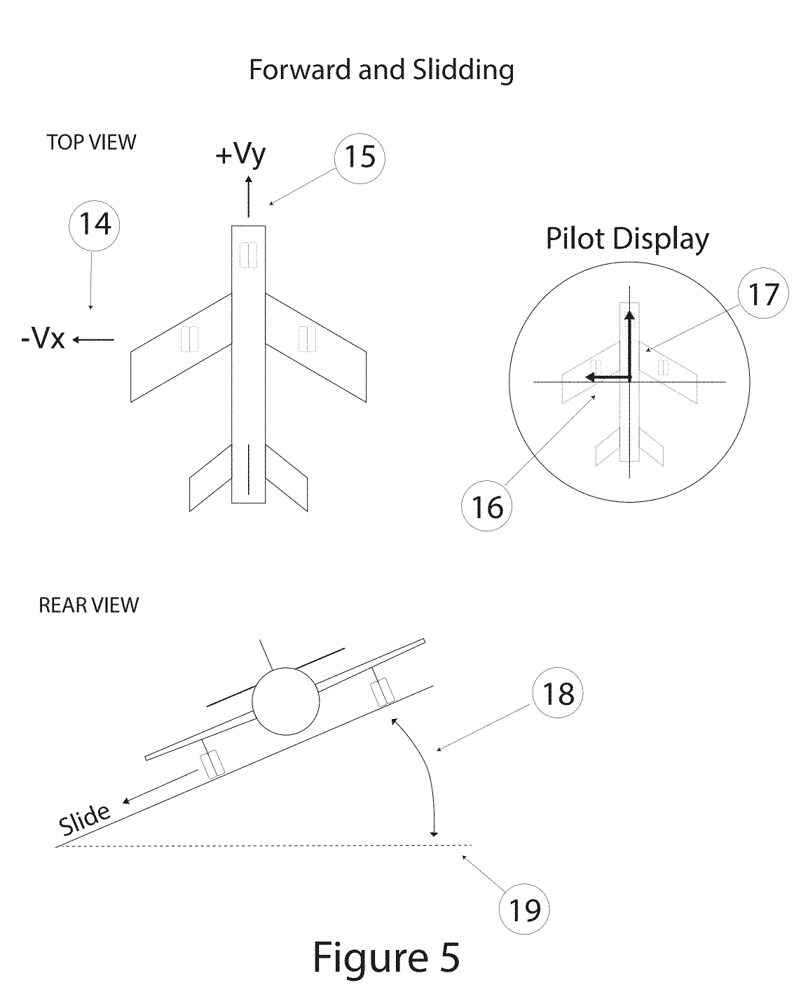

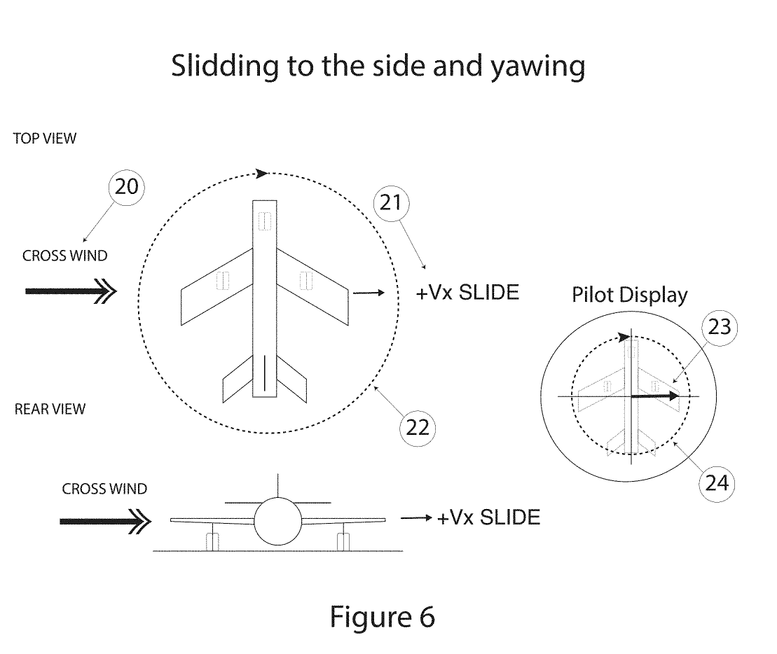

Corresponding to forward only movement 5 of the aircraft 6 supported by tires 8. FIG. 5 depicts an aircraft moving forward 15 and sliding to the side due to the sloping 18. The pilot display is presenting both a forward vector 17 and a lateral vector 16 indicating to the pilot that the aircraft is sliding as it moves forward. FIG. 6 depicts a aircraft subjected to a crosswind 20 resulting in yawing 22 and sliding 21. The pilot display shows the slide vector 23 as well as icon representing yawing 24. Pilot could be aided in his correction efforts by knowing that there is a yaw component to the slide.

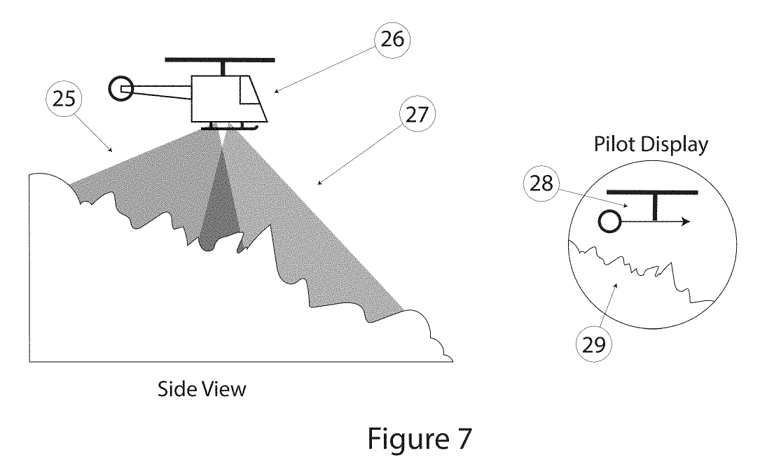

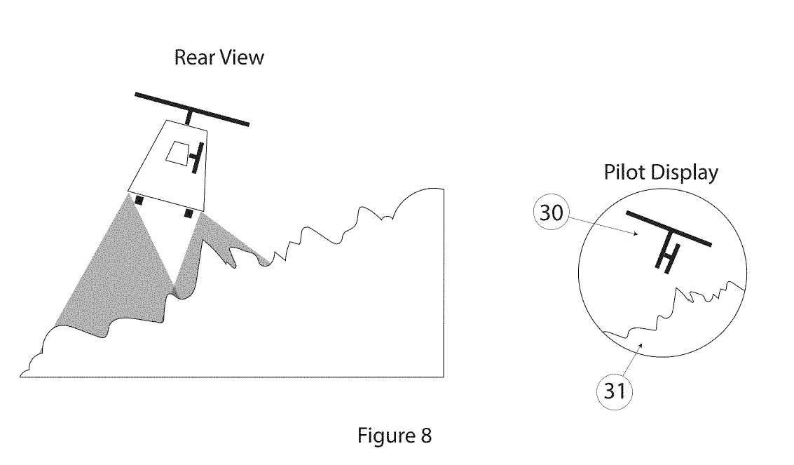

FIG. 7 depicts a rotorcraft 26 flying close to a sloping surface. The radar beams 26 and 27 are profiling the surface beneath the rotorcraft and displaying the profile of the surface 29 along with an icon representing the rotor craft 28 which communicates the alignment of the rotorcraft with the surface on the pilot display. FIG. 8 depicts a rotor craft rolled above a sloping surface as well as the corresponding pilot display showing the rotorcraft icon 30 and the surface profile 31

Commercial off the shelf (COTS) inexpensive 24-GHz radar modules, were used in the research for this invention. They measured the amplitude and the sign of the velocity (+ toward or − away from the sensor). And of velocities as low as ±0.4 mph. Measurement of the longitudinal velocity of the test vehicle was accomplished with Doppler measurements taken which were parallel to the longitudinal axis of the vehicle and with Doppler measurements which were taken at a 45-degree angle to the longitudinal axis of the vehicle. The component of the 45-degree measurement which represents the longitudinal movement is easily computed via the cosine of the angle between the longitudinal axis and the the velocity measured at 45-degrees.

This can also be accomplished by projecting the 45-degree vector onto the y-axis using the dot product of a unit vector parallel to the longitudinal axis of the aircraft and the component of the velocity parallel to the 45-degree axis via the Equation:

$$\vert \overline{{V}_{y - axis}} \vert = \frac{\overline{{\hat{e}}_{y - axis}} * \overline{{V}_{45}}}{cos ( θ )}$$

where:

ê̅_̅{̅y̅-̅a̅x̅i̅s̅}̅ is the unit vector pointing along the y-axis

V̅₄̅₅̅ is the component of the velocity vector along the 45-degree axis

|V̅_̅{̅y̅-̅a̅x̅i̅s̅}̅| is the magnitude of the velocity parallel to the y-axis

• is the dot product (or inner product) of two vectors

The problem of measuring one dimensional (1-D) movement of land vehicles over the ground is a long standing one. Farm machinery working in plowed fields inevitably have their wheels slipping. This was solved decades ago by placing Doppler radar units under the tractors. The radar sets were based on the Gunnplexer cavity and horn radar widely used in police radar since the 1960's. The high-speed French train (Le Train a Grande Vitesse, TGV) required accurate speed and distance traveled measurements for their highest level safety systems. Train wheels slip during braking and during startup—thus the TGV uses a voting scheme selecting from: an odometer on the wheels, Doppler radar, and a radar cross-correlation speed measurement

The Doppler shift is given by: f_{D}=(±2v/c)f_{T} where: f_{D} is the Doppler shift, v is the velocity toward (+shift) or away (−shift) from the radar, c is the speed of light, and f_{T} is the transmitted continuous wave (CW). For example for a Doppler shift as 65 Hz for a patch-of-the-surface approaching the radar at 0.38 mph. If the surface is at a 22.5-degree angle with the radar, the Doppler shift is 60 Hz. Reading further—a 10% error in speed measurement corresponds to 6 Hz in Doppler frequency. To make a measurement with 6 Hz accuracy requires on the order of 167 milliseconds. The implication of this is that six measurements per second can be taken—each with a 10% accurate speed measurement at a speed of 0.38 mph. Thus the measurement time is inversely related to the Doppler frequency and the Doppler frequency is directly proportional to the transmitter frequency. The result is that for a fixed velocity and desired accuracy—a higher transmitter frequency, F_{T} will result in a shorter measurement time and more measurements per second. Which is one reason 60 GHz is the preferred frequency chosen from available COTS products for the experimental work carried out.

The angle the radar beam makes with the surface of the deck affects not only the Doppler frequency for a given rate of travel, but also affects the strength of the microwave radiation returned from the 7-inch patch illuminated by the narrow eight-degree (in elevation and in azimuth) radar beam. Scanning perpendicular to the surface results in mirror-like returns—called specula returns. These can be very strong, but produce no Doppler shift as the movement is perpendicular (90 degrees) to the radar beam. As the angle with the surface is decreased from 90 degrees the variation of the strength of the returns as the angle of scanning varies in a highly nonlinear fashion.

In the vast majority of short range radar systems—including automotive radars and police radars—the transmitter and the receiver run continuously and simultaneously. Thus unless great care is taken, RF can leak from the transmitting signal path into the receiver path causing many problems such as saturating the low noise amplifier of the receiver or appearing as a target at short range. The radar chosen for the research for this invention was carefully designed to minimize these effects so that short range measurements at less than one foot are possible. However, the placement of the radars on the aircraft is equally important and attention must be paid to the possibility of reflections from airframe structures or waves bouncing and re-bouncing off the ground which is only a few feet distant in the case of mounting under a UAV.

Thus one requirement for the radar system is that it makes Doppler measurements only from the patch of the surface just beneath the aircraft and any reflections arising from subsequent bounces and the returns that they generate can be identified by their range and suppressed. Measuring Doppler from a particular set of range cells is routinely carried out by pulse-Doppler radar and can be carried out with other range-measuring radar such as Frequency Modulated Continuous Wave (FMCW) radar.

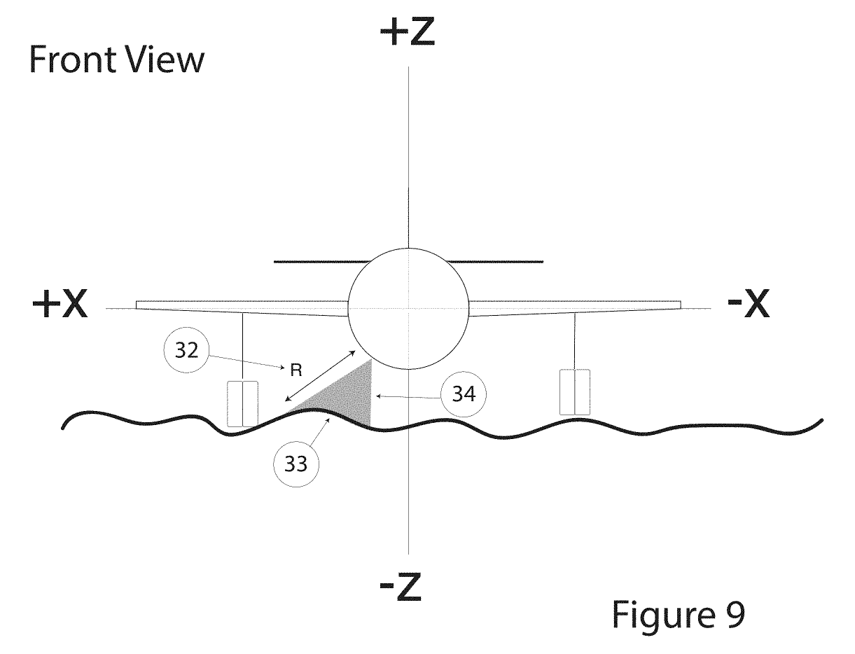

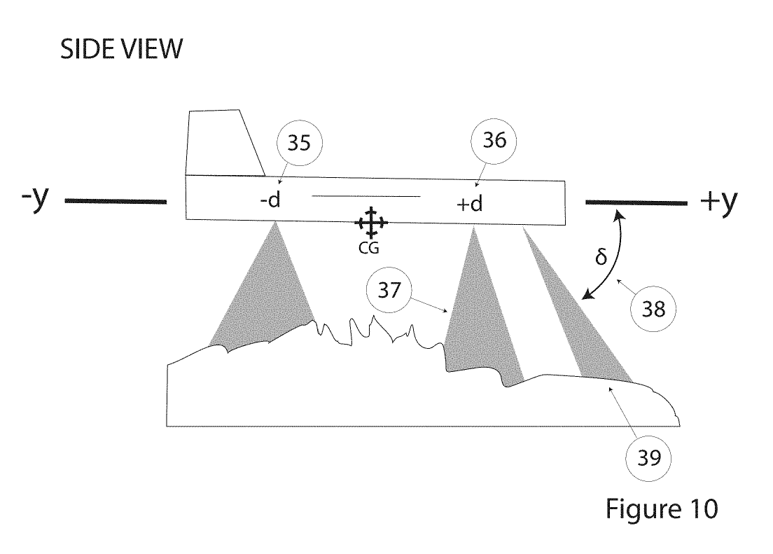

The concept for measuring the low speed lateral and longitudinal movement of a UAV over a surface is depicted in FIG. 9 and FIG. 10. In FIG. 9, a beam of range R 32 scanning in the +x direction 34 is illuminating the surface 33. Two radar beams scanning from positions offset from the center of gravity a distance, ±d, 35 and 36 as shown in FIG. 10 can be used to measure the total velocity parallel to the x-axis, vₓ, and to extract the contribution to the total from the yaw rate, co. The two rates can then be separately reported to the pilot as depicted in FIGS. 5 17 and 16. The generation of Doppler from translation and rotation are governed by the following equations.

$${f}_{Doppler \cdot x}^{+ d} = \{ \frac{+ 2 \cdot \vert d \vert \cdot ω \cdot sin \{ {tan}^{- 1} [ \frac{d}{R} ] \} \cdot cos ( δ )}{c} + \frac{2 \cdot {v}_{x} \cdot cos ( δ )}{c} \} \cdot {f}_{xmit}$$

$${f}_{Doppler \cdot x}^{- d} = \{ \frac{- 2 \cdot \vert d \vert \cdot ω \cdot sin \{ {tan}^{- 1} [ \frac{d}{R} ] \} \cdot cos ( δ )}{c} + \frac{2 \cdot {v}_{x} \cdot cos ( δ )}{c} \} \cdot {f}_{xmit}$$

f_{xmit·+x}: is the transmitter frequency (Hz) of the transmitter illuminating the surface at a dip angle, δ. transmitting in the +x direction parallel to the x-axis.

vₓ: is the component of any translational velocity of the center of gravity parallel to the x-axis.

±d: distance from the center of gravity along the y-axis.

±ω: rotation rate (radians/second) and direction (±) of the aircraft yawing about the center of gravity.

+ω is counter clockwise rotation and −ω is clockwise rotation.

f_{Doppler·x·ω}^{-d}: the Doppler frequency shift of the received waves due to translational motion parallel to the x-axis and due to yaw rotational rates, ±ω, for beams which scan in the +x direction parallel to the x=axis from the point y=−d.

f_{Doppler·x·ω}^{+d}: the Doppler frequency shift of the received waves due to translational motion of the center of gravity parallel to the x-axis and due to yaw rotational rates, ±ω, about the center of gravity for beams which scan in the +x direction parallel to the x=axis from the point y=+d.

A surface-movement-awareness system for use in conjunction with a pilot of an aircraft operating with landing gear substantially in contact with a surface, wherein the aircraft's translational velocities and rotational rates with respect to the surface and other information are obtained from electromagnetic sensor measurements, wherein visible icons or audible messages or tactile patterns generated from an analysis of the measurements are presented to the pilot to provide awareness that the aircraft is failing to move in the direction commanded by the pilot to enable the pilot to issue revised commands to prevent accidents; comprising at least on first sensor located on the y-axis of the aircraft at y=+d, the sensor is capable of measuring a velocity parallel to the y-axis, v_{y}, and is capable of measuring bidirectional velocities parallel to the x-axis, vₓ, the magnitude of vₓ is a vector sum of: a component of a translational velocity parallel to the x-axis and of a component of the yaw rate, Rω, parallel to the x-axis, and providing at least one first signal indicative of this information; and at least one second sensor located on the y-axis of the aircraft at y=−d, the sensor is capable of measuring bidirectional velocities parallel to the y-axis, −v_{y}, and is capable of measuring bidirectional velocities parallel to the x-axis, vₓ, the magnitude of vₓ is a vector sum of: a component of a translational velocity parallel to the x-axis and of a component of the yaw rate, Rω, parallel to the x-axis, and providing at least one second signal indicative of this information; and at least one first processor, the at least one first processor capable of analyzing the first signal in conjunction with the second signal in order to provide at least one further signal indicative of: a longitudinal velocity vector indicative of longitudinal translation of the center of gravity of the aircraft with respect to the surface; and a lateral velocity vector indicative of lateral translation of the center of gravity of the aircraft with respect to the surface; and a yaw rate indicative of a rotation with respect to the surface about a vertical axis passing through the center of gravity of the aircraft; and other information with respect to the surface, the at least one first processor is operatively connected to at least one communication device, for communicating the further signal; and providing at least one means for receiving the at least one further signal communicated from the at least one first processor and transferring the information conveyed by the at least one further signal to at least one second processor; the at least one second processor is operatively connected to a pilot display; the at least one second processor is operatively connected to an audible pilot alerting device, a tactile pilot alerting device or other pilot alerting devices; the at least one second processor analyzes the information conveyed by the at least one further signal, and selects: at least one predefined icon for display to the pilot to convey information on the longitudinal velocity, the lateral velocity, the yaw rate, and other information;

the at least one second processor analyzes the information conveyed by the at least one further signal in search of variables that are outside of predefined operational bounds, and selects: at least one audible alert message, at least one tactile alert message, at least one icon, or other alerting means corresponding to out of bounds conditions; if the at least one pilot's analysis of the aircraft's current condition differs substantially from the condition commanded by the at least one pilot, the at least one pilot may issue revised commands to at least prevent accidents, and to at least recover from: slipping, sliding, and other uncommanded movements.

The system wherein the at least one pilot commanding the aircraft's movement is replaced by an autonomous flight control processor; the autonomous flight control processor is located onboard the aircraft; and the autonomous flight control processor is equipped with at least one means for receiving the at least one further signal communicated from the at least one first processor and transferring the information conveyed by the at least one further signal to at least one autonomous flight control processor; the at least one autonomous flight control processor is capable of analyzing the information conveyed by the at least one further signal to estimate the actual movements of the aircraft with respect to the surface; further the at least one autonomous flight control processor is capable of comparing the aircraft's actual movements with respect to the surface to the commanded movements with respect to the surface issued by the autonomous flight control processor; if the autonomous flight control processor's estimates of the aircraft's actual movements with respect to the surface differ substantially from the commanded movements with respect to the surface the at least one flight control processor is capable of issuing revised commands to attempt to at least prevent accidents, the at least one flight control processor is capable of issuing revised commands to recover from slipping, sliding, and other uncommanded movements.

The system wherein the landing gear is equipped with at least three wheels, each of the at least three wheels is equipped with a wheel-rotation-rate sensor, the wheel-rotation-rate sensors are operatively connected to the autonomous flight control processor, the autonomous flight control processor is capable of analyzing the measured rotational rates of the wheels, the autonomous flight control processor is further capable of converting the measured values of the lateral velocity, the longitudinal velocity, and the yaw rate to estimates of rotation rates of each of the wheels, in the event the measured rotational rates of the wheels differ substantially from the estimated rotational rates, aid autonomous flight control processor is able to detect a problem such as: wheel slippage, wheels sliding, wheels locking and other losses of gripping of the surface, in the event at least one of the problems is detected, the at least one autonomous flight control processor can initiate antilock braking measures to recover from potential accidents.

A surface motion awareness system for use in conjunction with a least one remotely located pilot of an aircraft, the aircraft is in the air near a surface for purposes of: landing on the surface, taking off from the surface, hovering over the surface, and otherwise maneuvering near the surface; at least two sensors attached to the aircraft at predetermined locations: at least one first sensor employs electromagnetic waves to scan parallel to the lateral axis to provide information including; at least measurements of a distance from the aircraft to the surface as a function of the angle defined in a coordinate system whose origin is the center of gravity of the aircraft and providing at least one first signal indicative of the information; and at least one second sensor employs electromagnetic waves to scan parallel to the longitudinal axis to provide information including: at least measurements of a distance from the aircraft to the surface as a function of the angle defined in the coordinate system whose origin is the center of gravity of the aircraft, and providing at least one second signal indicative of the information; at least one first processor, the at least one first processor capable of analyzing the at least one first signal and combining the results of the analysis of the at least one first signal with an analysis of the at least one second signal in order to provide at least one further signal indicative of the aircraft's alignment with respect to the surface and indicative of a profile of the surface with respect to the aircraft; the at least one first processor is operatively connected to a communication device for communicating the further signal; and at least one means for receiving the at least one further signal communicated from the at least one first processor and transferring the information conveyed by the at least one further signal to at least one second processor; the at least one second processor is operatively connected to a pilot display; the second processor analyzes the information conveyed by the at least one further signal, and selects at least one predefined icon for display on the at least one pilot's pilot display; the at least one second processor controls the presentation of the at least one predefined icon by analyzing information provided via the at least one further signal; the presentation of the at least one icon to provide an awareness of: the aircraft's alignment with respect to the surface and a profile with respect to the aircraft of the surface to the at least one remotely located pilot to increase the safety of operations near the surface.

### Definitions

1. X-Y-Z Coordinate System—Sensor locations and directions of movement are defined by a three axis orthogonal coordinate system whose origin is coincident with the center of gravity of the aircraft. See FIG. 1. The coordinate system's y-axis passes through the center of gravity of the aircraft and lies parallel to the longitudinal axis of the aircraft. The coordinate system's x-axis passes through the center of gravity of the aircraft and lies parallel to the lateral axis of the aircraft. The z-axis is perpendicular to the x-y plane of the aircraft and may represent the altitude of the aircraft above a surface. Velocities parallel to the x-axis (lateral velocities) are assigned the notation: Vₓ. Velocities parallel to the y-axis (longitudinal velocities) are assigned the notation: V_{y}.

2. Angles—A 360-degree angle is referenced to 0 degrees on the +y-axis and increases in angle clockwise. Yaw angles are referenced to 0 radians on the +x-axis and rotating clockwise (negative direction) for 2π radians returning to the +x-axis. The yaw rate of rotation is represented by co (radians/sec).

3. Surface—A surface on which, or near which, an aircraft may be operating includes: asphalt and concrete runways, ship decks, helicopter platforms, open water, grassy or sandy earth, ice and snow as well as other rigid and pliant materials. These surfaces are characterized by having no identifiable features which the radar could isolate and track. Rather they are comprised of randomly oriented facets which reflect the illuminating radiation in various directions.

The reflection process is most effective if the wavelength of the incoming radiation is similar to the average dimensions of the facets. For example 60-GHz waves' wavelength is 5 mm which is on the same order as the dimensions of the gravel in a typical asphalt runway.

4. Close or Near a Surface—This applies to an aircraft which is: landing, taking off, hovering, or operating similarly. Close, or near, a surface is defined as the altitude above a planar surface at which the extremities of an aircraft's structure graze the surface if the aircraft is rolled ±90 degrees or pitched ±90 degrees.

5. Electromagnetic waves—Radiation waves including: microwaves, millimeter waves, optical waves, infrared waves, and other waves.

6. Sensor—Sensors are defined as electromagnetic wave transceivers coupled to a beam steering antenna array. Beam steering moves a narrow beam of radiation through at least 90 degrees plus two beam widths. Thus a transceiver mounted on the y-axis could scan along the y-axis in the +y direction (0 degrees) and then steer the beam to 90 degrees and scan parallel to the x-axis.

The sensors measure: velocity of the surface approaching the sensor or of the surface receding from the sensor via the Doppler technique, and the angle of a reflection from a surface via the beam steering mechanism using an array of at least two receiver chains each coupled to an antenna.

The Doppler shift is given by

Δf_{D}=(2y/c)f_{T}

where:

v=±|v| is the velocity of the target, toward (+) or away (−) in meters/sec

c=speed of electromagnetic radiation in free space, 3*10⁸ meters/sec

Δf_{D} is the frequency shift from f₇ caused by motion of the target (Hz)

f_{T} is the continuous frequency transmitted from the radar (Hz)

With the transceiver operating in a continuous wave (CW) mode there is no discrimination in range. That is moving reflectors directly below the aircraft as well as reflectors illuminated by radiation which bounces off of the surface and reflects from a distant moving object are indistinguishable. This problem can be overcome by using a mode of operation which measures the distance of reflectors. The most common of such techniques is the frequency modulated continuous wave (FMCW) technique. It is closely related to CW—differing in that the transmitted frequency is modulated such that distance is encoded as frequency. That is it is a distance-to-frequency converter. Since in the case of scanning from the aircraft to the surface is at a fixed distance, one can solve the equation for the fixed distance and extract the Doppler. The relationships are as follows:

Another variable is the duration of the chirp, T. This will be adapted to the current velocity. Thus in the first term of Equation 1: β and R are fixed and T will vary with the current velocity. The relationships are established by Equation 1. The total frequency shift is the sum of the Doppler shift and the range of a reflection encoded by the FMCW process.

$$Δ {f}_{shift} = ( \frac{β}{T} ) ( \frac{2 R}{c} ) \pm ( \frac{2 v}{c} ) {f}_{T}$$

Where:

Δf_{shift} is the total frequency shift from FMCW for a range, R, plus a Doppler shift for velocity, v.

β is the bandwidth of the frequency sweep (360 MHz for this mode of operation)

T is the duration of the sweep, sec (varies between: 9 ms and 50 ms depending on the speed range

R is the range of the target, m (set to 3 m for 2-m UAV height and 45-degree dip angle)

c is the speed of light (3×10̂8 m/sec)

f_{T} is the transmitter frequency (60 GHz)

7. Projection of Measurements onto the x & y axis's—if the, for example, the velocity parallel to the y-axis, V_{y-axis}, is required for display to the pilot, the velocity can be measured for some other angle off of the y-axis—45 degrees in what follows. The relationship:

$$\vert \overline{{V}_{y - axis}} \vert = \frac{\overline{{\hat{e}}_{y - axis}} * \overline{{V}_{45}}}{cos ( θ )}$$

where:

ê̅_̅{̅y̅-̅a̅x̅i̅s̅}̅ is the unit vector pointing along the y-axis

V̅₄̅₅̅ is the component of the velocity vector along the 45-degree axis

|V̅_̅{̅y̅-̅a̅x̅i̅s̅}̅| is the magnitude of the velocity parallel to the y-axis

• is the dot product (or inner product) of two vectors

projects a vector measured at 45 degrees onto the y-axis. Thus in the Claims which follow a measurement described as V_{y-axis} may be the projection of a measurement made with the beam steered to an angle off of the y-axis.

8. Antilock braking systems (ABS) and wheel rotation rate sensors—ABS are in use throughout the worldwide automotive fleet. They employ typically magnetic rotation rate sensors on each of the vehicle wheels. An ABS control processor compares the rotational rates of the wheels. If one wheel is rotating at a rate higher than the others it is an indication that it has lost its grip on the surface and the ABS control processor applies braking to the wheel.

Although the invention has been described with respect to various embodiments, it should be realized this invention is also capable of a wide variety of further and other embodiments within the spirit and scope of the appended claims.

Although the invention has been described with respect to various embodiments, it should be realized this invention is also capable of a wide variety of further and other embodiments within the spirit and scope of the appended claims.

What is claimed is:

1. A surface-movement-awareness system for use in conjunction with a pilot of a commercial aircraft operating with landing gear substantially in contact with a surface, wherein the aircraft's translational velocities and rotational rates with respect to said surface and other information are obtained from electromagnetic sensor measurements, wherein visible icons or audible messages or tactile patterns generated from an analysis of said measurements are presented to the pilot to provide awareness that the aircraft is failing to move in the direction commanded by the pilot to enable the pilot to issue revised commands to prevent accidents; comprising
at least on first sensor located on the y-axis of said aircraft at y=+d, said sensor is capable of measuring a velocity parallel to the y-axis, v_{y}, and is capable of measuring bidirectional velocities parallel to the x-axis, vₓ, the magnitude of vₓ is a vector sum of: a component of a translational velocity parallel to the x-axis and of a component of the yaw rate, Rω, parallel to the x-axis, and providing at least one first signal indicative of this information; and
at least one second sensor located on the y-axis of said aircraft at y=−d, said sensor is capable of measuring bidirectional velocities parallel to the y-axis, −v_{y}, and is capable of measuring bidirectional velocities parallel to the x-axis, vₓ, the magnitude of vₓ is a vector sum of: a component of a translational velocity parallel to the x-axis and of a component of the yaw rate, Rω, parallel to the x-axis, and providing at least one second signal indicative of this information; and
at least one first processor, said at least one first processor capable of analyzing said first signal in conjunction with said second signal in order to provide at least one further signal indicative of:
a longitudinal velocity vector indicative of longitudinal translation of the center of gravity of the aircraft with respect to said surface; and
a lateral velocity vector indicative of lateral translation of the center of gravity of the aircraft with respect to said surface; and
a yaw rate indicative of a rotation with respect to said surface about a vertical axis passing through the center of gravity of the aircraft; and
other information with respect to said surface,
said at least one first processor is operatively connected to at least one communication device, for communicating said further signal; and
providing at least one means for receiving said at least one further signal communicated from said at least one first processor and transferring said information conveyed by said at least one further signal to at least one second processor;
said at least one second processor is operatively connected to a pilot display;
said at least one second processor is operatively connected to an audible pilot alerting device, a tactile pilot alerting device or other pilot alerting devices;
said at least one second processor analyzes said information conveyed by said at least one further signal, and selects: at least one predefined icon for display to said pilot to convey information on the longitudinal velocity, the lateral velocity, the yaw rate, and other information;
said at least one second processor analyzes said information conveyed by said at least one further signal in search of variables that are outside of predefined operational bounds, and selects: at least one audible alert message, at least one tactile alert message, at least one icon, or other alerting means corresponding to out of bounds conditions;
if said at least one pilot's analysis of said aircraft's current condition differs substantially from the condition commanded by said at least one pilot, said at least one pilot may issue revised commands to at least prevent accidents, and
to at least recover from: slipping, sliding, and other uncommanded movements.

2. The system as defined in claim 1 and claim 6, wherein said one at least one pilot commanding said aircraft's movement is located outside of the aircraft, and said pilot is remotely commanding said aircraft's movement; and said pilot display is located so as to be viewable by said at least one remotely located pilot.

3. The system of claim 1 and claim 6, wherein said at least one pilot commanding said aircraft's movement is replaced by an autonomous flight control processor;
said autonomous flight control processor is located onboard said aircraft; and
said autonomous flight control processor is equipped with at least one means for receiving said at least one further signal communicated from said at least one first processor and transferring said information conveyed by said at least one further signal to at least one autonomous flight control processor;
said at least one autonomous flight control processor is capable of analyzing said information conveyed by said at least one further signal to estimate the actual movements of said aircraft with respect to the surface; further
said at least one autonomous flight control processor is capable of comparing said aircraft's actual movements with respect to the surface to the commanded movements with respect to the surface issued by said autonomous flight control processor; if
said autonomous flight control processor's estimates of said aircraft's actual movements with respect to the surface differ substantially from said commanded movements with respect to the surface said at least one flight control processor is capable of issuing revised commands to attempt to at least prevent accidents, said at least one flight control processor is capable of issuing revised commands to recover from slipping, sliding, and other uncommanded movements.

4. The system of claim 1, wherein said landing gear is equipped with at least three wheels, each of said at least three wheels is equipped with a wheel-rotation-rate sensor, said wheel-rotation-rate sensors are operatively connected to said autonomous flight control processor, said autonomous flight control processor is capable of analyzing the measured rotational rates of the wheels, said autonomous flight control processor is further capable of converting the measured values of said lateral velocity, said longitudinal velocity, and said yaw rate to estimates of rotation rates of each of said wheels, in the event said measured rotational rates of the wheels differ substantially from said estimated rotational rates, aid autonomous flight control processor is able to detect a problem such as: wheel slippage, wheels sliding, wheels locking and other losses of gripping of said surface, in the event at least one of said problems is detected, said at least one autonomous flight control processor can initiate antilock braking measures to recover from potential accidents.

5. The system of claim 1 and claim 6 and claim 7 wherein said at least one first sensor and said at least one second sensor scan with electromagnetic waves, the frequency of said electromagnetic waves corresponds to a region of the electromagnetic spectrum of high absorption of said electromagnetic waves, at least one region of high adsorption of electromagnetic waves is located in the vicinity of 60 GHz.

6. A surface motion awareness system for use in conjunction with a least one remotely located pilot of an aircraft in commercial service, said aircraft is in the air near a surface for purposes of: landing on said surface, taking off from said surface, hovering over said surface, and otherwise maneuvering near said surface;
at least two sensors attached to said aircraft at predetermined locations:
at least one first sensor employs electromagnetic waves to scan parallel to the lateral axis to provide information including;
at least measurements of a distance from said aircraft to said surface as a function of the angle defined in a coordinate system whose origin is the center of gravity of said aircraft and providing at least one first signal indicative of said information; and
at least one second sensor employs electromagnetic waves to scan parallel to the longitudinal axis to provide information including:
at least measurements of a distance from said aircraft to said surface as a function of the angle defined in said coordinate system whose origin is the center of gravity of said aircraft, and providing at least one second signal indicative of said information;
at least one first processor, said at least one first processor capable of analyzing said at least one first signal and combining the results of the analysis of said at least one first signal with an analysis of said at least one second signal in order to provide at least one further signal indicative of said aircraft's alignment with respect to said surface and indicative of a profile of the surface with respect to said aircraft; said at least one first processor is operatively connected to a communication device for communicating said further signal; and
at least one means for receiving said at least one further signal communicated from said at least one first processor and transferring said information conveyed by said at least one further signal to at least one second processor; said at least one second processor is operatively connected to a pilot display;
said second processor analyzes said information conveyed by said at least one further signal, and selects at least one predefined icon for display on said at least one pilot's pilot display; said at least one second processor controls the presentation of said at least one predefined icon by analyzing information provided via said at least one further signal;
said presentation of said at least one icon to provide an awareness of: said aircraft's alignment with respect to said surface and a profile with respect to said aircraft of said surface to said at least one remotely located pilot to increase the safety of operations near the surface.

7. A method for a surface-movement-awareness system for use in conjunction with a pilot of a commercial aircraft operating with landing gear substantially in contact with a surface, wherein visible icons or audible messages or tactile patterns are presented to the pilot to provide awareness that the aircraft is failing to move in the direction commanded by the pilot to enable the pilot to issue revised commands to prevent accidents; comprising
obtaining
information about said aircraft from at least one first signal derived from at least one first sensor for sensing movement over said surface, said at least one first sensor is attached to said aircraft at a predetermined location, said at least one first sensor employs electromagnetic waves for sensing information about said aircraft's longitudinal movement with respect to said surface, and sensing other information, and
providing
at least one first signal indicative of said longitudinal movement and said other information; and
obtaining
information about said aircraft from at least one second signal derived from at least one second sensor for sensing movement over said surface, said at least one second sensor is attached to said aircraft at a predetermined location, the at least one second sensor employs electromagnetic waves for sensing information about the aircraft's longitudinal movement with respect to said surface, and sensing other information, and
providing
at least one second signal indicative of said longitudinal movement and said other information; and
analyzing with at least one first processor, the at least one first processor capable of analyzing said at least one first signal and combining the results of the analysis of said at least one first signal with an analysis of said at least one second signal, in order to provide at least one further signal indicative of said aircraft's movement with respect to the surface and other information; said further signal conveys information about:
at least one further signal indicative of said aircraft's movement with respect to the surface, said further signal conveys information about:
said aircraft's longitudinal velocity vector with respect to said surface and projected onto the longitudinal axis of said aircraft, and
said aircrafts' said lateral velocity vector with respect to said surface and projected onto the lateral axis of said aircraft, and
said aircraft's yaw rate about the center of gravity of said aircraft, and
communicating
said at least one first processor is operatively connected to a communication device for communicating said further signal; and
receiving,
at least one means for receiving said at least one further signal communicated from said at least one first processor and transferring said information conveyed by said at least one further signal to at least one second processor; said at least one second processor is operatively connected to a pilot flight information display;
displaying
said second processor analyzes said information conveyed by said at least one further signal, and selects at least one predefined icon for display by
said pilot flight information display; said at least one second processor controls the presentation of said at least one predefined icon by analyzing information provided via said at least one further signal;
presenting
said second processor analyzes said information conveyed by said at least one further signal, and selects at least one predefined icon for display by
said pilot flight information display; said at least one second processor controls the presentation of said at least one predefined icon by analyzing information provided via said at least one further signal;
revising
in the event said pilot's analysis of said aircraft's actual movement differs from said commanded movement, said at least one pilot can issue revised commands to at least prevent accidents, and said at least one pilot can issue revised commands to recover from uncommanded: slipping, sliding, and other uncommanded movements.
